(19) United States
(12) Patent Application Publication
(10) Pub. No.: US 2026/0319854 A1
(43) Pub. Date: Oct. 15, 2026

(54) INTELLIGENT ORCHESTRATION OF PROCESSING RESOURCES FOR PIPELINES

(71) Applicant: PAYPAL, INC., San Jose, CA (US)

(72) Inventors: Song Qiu, Shanghai (CN); Ashok kumar Sarvepalli, Fremont, CA (US)

(21) Appl. No.: 18/873,044

(22) PCT Filed: Dec. 22, 2023
(86) PCT No.: PCT/CN2023/140952

§ 371 Date: Dec. 9, 2024

(51) Int. Cl. G06F 9/50

(52) U.S. Cl. CPC G06F 9/5038

(57) ABSTRACT

Systems and methods for predicting computer resources to fulfil pipeline requests includes obtaining a processing pipeline request defining a first set of computing resources for allocation during a first time period, obtaining a first dataset corresponding to historical data and scheduled pipelines, determining an availability of computing resources during a second time period based on the request, and predicting a recommendation corresponding to a second set of computing resources and a third time period to fulfill the request, the prediction being determined based on the first dataset and the available computing resources. The operations may further include generating a second dataset as output, sending the second dataset to a second computing device, obtaining a third dataset corresponding to a user selection of one or more computing resources during the third time period, and coordinating with one or more other computing devices in the system to fulfill the request.

### CROSS-REFERENCE TO RELATED APPLICATIONS

This application is a U.S. National Phase Application of PCT/CN2023/140952, filed on Dec. 22, 2023, entitled “Intelligent Orchestration of Processing Resources for Pipelines,” the entire contents of which are hereby incorporated by reference, for all purposes, in their entirety.

### FIELD

The present disclosure relates to the field of data processing. More particularly, to intelligent orchestration of processing resources for data processing pipelines.

### BACKGROUND

Organizations typically utilize computing nodes connected via a network for data processing purposes, each computing node having CPU and/or GPU resources that may be leveraged to perform the various data processing tasks. For example, ML engineers or data scientists of an online merchant can leverage the CPU resources of the computing nodes to analyze transaction data and identify patterns indicative of fraudulent transactions. In addition, the ML engineers or data scientists of the online merchant can also leverage the GPU resources of the computing nodes to produce graphical representations of the analyzed transaction data. Although an organization may have a large number of CPU and GPU resources at their disposal such as, for example, through computing nodes connected via a cloud network, the total number of available computing nodes, and corresponding CPU and GPU resources, to perform the job requests and other operations associated with the entity at a given time is finite.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a block diagram illustrating an example networked system, according to some embodiments.

FIG. 2 is a flow diagram illustrating a method of predicting computing resources to fulfill pipeline requests, according to some embodiments.

FIG. 3 is a diagrammatic view of a system of FIG. 1, according to some embodiments.

FIG. 4 is a flow diagram illustrating a method, according to some embodiments.

FIG. 5 is a flow diagram illustrating a method, according to some embodiments.

FIG. 6 is a graphical illustration of a non-limiting example of a user interface, according to some embodiments.

FIG. 7 is a graphical illustration of another non-limiting example of the user interface, according to some embodiments.

FIG. 8 is a flow diagram of a method, according to some embodiments.

FIG. 9 is a flow diagram of a method, according to some embodiments.

FIG. 10 is a diagrammatic view of a system for performing the method of FIG. 9, according to some embodiments.

FIG. 11 is a block diagram illustrating a network-based system, according to some embodiments.

### DETAILED DESCRIPTION

ML engineers and Data Scientists leverage high-powered computing machines (e.g., computing nodes) to process data for various purposes based on an organization's business objectives. Known approaches for fulfilling data processing pipelines using computing devices connected over a network include a user (e.g., ML engineer or data scientist) submitting the request and defining the number of computing resources (e.g., processing resources) to allocate for the request. For example, the pipeline request can define 300 CPU cores, 100 GPU cards, and 35 Gigabits of memory to be allocated from the computing nodes connected to the network to fulfill the request. However, the number of computing resources being requested, and thereby reserved at the computing nodes on the network, for a particular pipeline may be more than optimally necessary to fulfill the processing pipeline.

Due to the limited number of available computing resources at the network, there may be an upper limit to the number of jobs that can run concurrently. As the number of pipeline requests increases on the network, orchestration of the available computing resources to fulfill the pipeline requests from engineers becomes challenging. For example, the number of computing resources may be limited by the number of available GPU cards in the computing nodes. In addition, as processing usage fluctuates based on demand, the resources may be underutilized at certain times, and overutilized at other times. This competition for resources amongst engineers during time periods of peak demand causes efficiencies in the network, thereby resulting in longer wait times caused by delays. For example, fulfillment may be delayed because the optimal amount of computing resources (e.g., CPU and GPU resources) for performing a particular pipeline request is not available due to increased demand.

The instant disclosure improves upon known methods for orchestrating computing resources to fulfill data processing pipelines by leveraging neural network models to predict optimal processing resource configurations for the computing nodes on a network based on application of one or more algorithms to historical data. The various embodiments of the present disclosure may also provide recommendations to the user based on the optimal processing resource predictions. Further, known approaches to orchestration of computing resources at computing nodes are generally limited to definitions in the processing request, that is, the request is queued for fulfillment and begins once the requested computing resources become available or the processing request is configured to be performed at a certain time of day when processing demand is typically lower than during peak times. The instant disclosure also improves upon known approaches by orchestrating data processing pipelines based on leveraging the neural network models to predict a time period to fulfill a pipeline request based on historical data. In addition, based on the prediction, recommendations for fulfilling the pipeline request may be provided as output based on future scheduled jobs and based on the available computing resources at the computing nodes.

In this regard, the various embodiments of the present disclosure improves the operation of computing devices in a network through optimally orchestrating computing resources at the computing nodes in a network to improve efficiency at the computing devices in the network by decreasing delays caused by inefficient orchestration of data processing pipelines and decreasing the number of processing cycles to perform the data processing pipelines, amongst other similar benefits.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

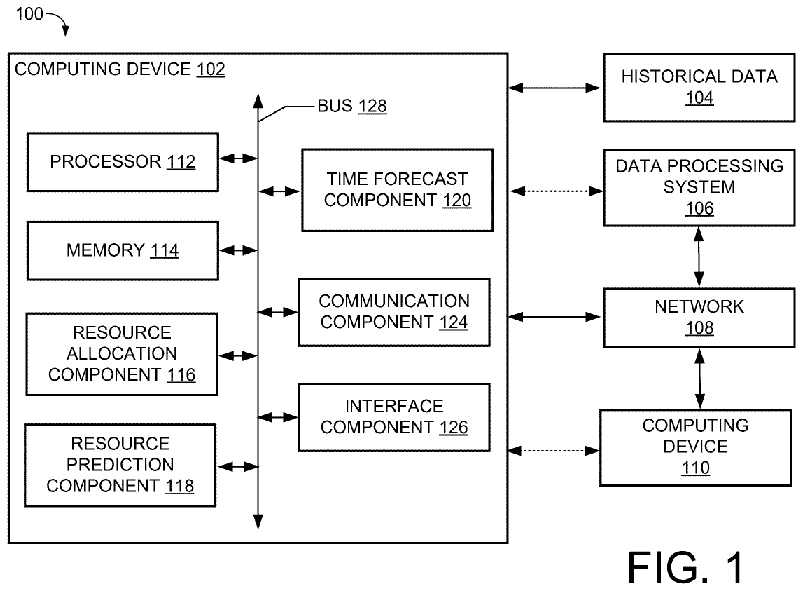

FIG. 1 is a block diagram illustrating an example networked system 100 for predicting computing resources for pipeline fulfillment, according to some embodiments. The system 100 may include computing device 102, a source of historical data store 104, a data processing system 106, a network 108. The computing device 102 may be in electronic communication with the data processing system 106. The data processing system 106 may include one or more computing devices (e.g., nodes), each computing device including CPU resources, GPU resources, and/or memory resources that may be configured to perform pipelines in series and/or in parallel on system 100. In some embodiments, the computing device 102 may be in electronic communication with the data processing system 106 via network 108, according to some embodiments.

The system 100 may include computing device 110 associated with a user (e.g., ML engineer or data scientist), the computing device 110 being in electronic communication with computing device 102 to send and receive data corresponding to pipelines therebetween. For example, pipeline requests and resulting output data from system 100 may be sent via an application programming interface (“API”). In some embodiments, the computing devices 110 may be in electronic communication with system 100 via network 108.

The computing device 102 may include a processor 112 and a non-transitory, computer-readable memory 114 that contains instructions that, when executed by the processor 112, cause the computing device 102 to perform operations, processes, methods, etc. described herein with respect to computing device 102. The computing device 102 may include one or more functional modules embodied in computer-readable memory 114. The functional modules may include a resource allocation component 116, a resource prediction component 118, a time forecast component 120, a communication component 124, an interface component 126, and a bus 128.

The instant disclosure refers to accounts, users, pipeline IDs, pipeline specific data, requested CPU, requested GPU, requested memory, duration, actual CPU utilization, timestamps, and other attributes. Such data may be common to all users of the network, a particular network, a particular type of pipeline request, etc. In some embodiments, the data may be for a particular user. For example, the requested CPU, requested GPU, actual CPU utilization, and pipeline specific data may be for a particular user to enable computing device 102 to determine processing resource predictions based on historical data associated with the user. Although this disclosure refers to historical data as context for novel methods and systems, it should be appreciated that such methods and systems may be applied to or in the context of a wide variety of computing actions, some of which may not be considered historical data. For example, where historical pipeline requests are considered, past resource availability may more broadly be considered. In another example, where historical pipeline requests are considered, future scheduled pipeline requests may also more broadly be considered.

The resource allocation component 116 may obtain, as input, characteristics of data processing system 106, such as number of computing devices, number of computing resources at each computing device, number of available computing resources at each computing device in data processing system 106. The resource allocation component 116 may determine the resource availability of data processing system 106 to enable computing device 102 to fulfill pipeline requests from users such as, the user of computing device 110, in real time.

The characteristics of data processing system 106 may include timestamp data associated with the allocated computing resources. For example, at a particular computing node, a time period estimate for when a particular number of GPU resources is allocated to perform a different pipeline request is provided to resource allocation component 116 to enable computing device 102 to orchestrate future pipeline requests.

The resource allocation component 116 may obtain, as input, a data processing pipeline request with definitions including a request for computing resources. The processing resource definitions can include CPU resources (e.g., CPU cores), GPU resources (e.g., GPU cards), and memory (e.g., in bytes). In some embodiments, the definitions may include a time period (e.g., time slot) for performing the request using the requested computing resources. For example, the request may define the data processing request be performed on the system 100 between 1 to 3 PM.

The resource allocation component 116 may be configured to perform the operations, methods, processes in cooperation with the resource prediction component 118 and time forecast component 120 to enable computing device 102 to predict the computing resources that may be needed to fulfill pipeline requests and to enable orchestrating executing of the pipeline request on system 100, as will be further described herein. In addition, the resource allocation component 116 may leverage the application of one or more machine learning models or neural network models by the resource prediction component 118 and/or time forecast component 120 to incoming pipeline requests, data in historical data store 104, historical and scheduled jobs at data processing system 106, other like data, or any combinations thereof, to enable the resource allocation component 116 to determine computing resource predictions capable of fulfilling the pipeline requests.

The computing resource prediction may include one or more different types of computing resources, and a quantify of each type of computing resource, which may be needed to fulfill the request. For example, the prediction may estimate that 10 CPU cores may be needed to perform the processing pipeline request. In another example, the request may define 30 CPU cores, 15 GPU cards, and 150 GB of memory for the pipeline request, and the computing device 102 may predict that 15 CPU cores, 8 GPU cards, and 100 GB of memory are needed to fulfill the pipeline request based on the one or more definitions included in the request and based on the historical data of the user's previous pipeline requests. The prediction may also include a time period for performing the pipeline. In some embodiments, the prediction may include one or more time periods for performing the pipeline request. The time periods may be based on the computing resources allocated to perform the request, the available resources at the data processing system 106 when the request is orchestrated, and other like factors. For example, the forecast may define one or more time periods the data processing system 106 may fulfill the processing tasks in the request based on previous historical requests (e.g., historical request data) from the user and that avoid peak resource demand times at data processing system 106. In this regard, the one or more time periods may include alternative optimal time periods for executing the pipeline request using data processing system 106 if the time period defined in the request is predicted to be highly congested, thereby avoiding delays compared to the request being performed at the originally defined time period in the pipeline request.

Based on the prediction, the resource allocation component 116 may be configured to allocate the computing resources at data processing system 106 to fulfill the request. If the request and/or prediction includes a defined time period, the resource allocation component 116 may allocate the computing resources at data processing system 106 at the defined time period. In some embodiments, the resource allocation component 116 may allocate resources of data processing system 106 based on a priority system that considers both historical preferences and current resource constraints. For example, if a previous pipeline request being fulfilled on data processing system 106 is delayed, but shares resources that were scheduled to be allocated to a present pipeline request, the resource allocation component 116 may adaptively allocate the computing resources at data processing system 106 based on a priority approach that considers both historical preferences of users with processing pipeline jobs at data processing system 106 and current resource constraints at data processing system 106.

The resource allocation component 116 may also be configured to monitor the performance of the pipeline fulfillment operations of computing device 102 and may be configured to refine the recommendation and allocation process based on the monitoring. In some embodiments, the resource allocation component 116 may be configured to collect feedback on the performance of computing device 102 in predicting and orchestrating resource allocation from users that submit data processing pipeline requests to system 100 such as, for example, the user of computing device 110 and may analyze the feedback and incorporate the data to further refine the recommendation and allocation process.

The resource prediction component 118 may be configured to apply one or more models to predict a number of computing resources that may be optimally allocated to fulfill a pipeline such as, for example, from computing device 110. The resource prediction component 118 may apply the one or more models to data such as past pipeline job runs, historical time slots, and previous CPU resource/GPU resource/memory resource usage for similar types of pipeline requests. In this regard, the resource prediction component 118 may also be configured to apply the one or more models to analyze and classify pipeline requests, that is, the resource prediction component 118 may apply the models to compare the user provided definitions in the pipeline request to past pipeline job runs to identify similar historical pipeline job runs and identify actual processing resource utilization for the historical pipeline job runs, according to some embodiments.

The time forecast component 120 may be configured to identify broader resource demand patterns over time periods, which may be broader than the time period defined in the pipeline request such as, for example, a pipeline request from the user of computing device 110. In this regard, the time forecast component 120 may consider factors including, but not limited to, time of day, actual resource utilization, historical resource utilization, future pipeline requests, historical pipeline requests, other like data, or any combinations thereof, to determine optimal time periods for fulfilling pipeline requests. For example, the time forecast component 120 may predict a time period to complete the pipeline request based on historical metrics of similar pipeline requests from the user of computing device 110 and/or from one or more users of system 100. The time forecast component 120 may be configured to perform the operations, methods, processes in cooperation with resource prediction component 118 and resource allocation component 116.

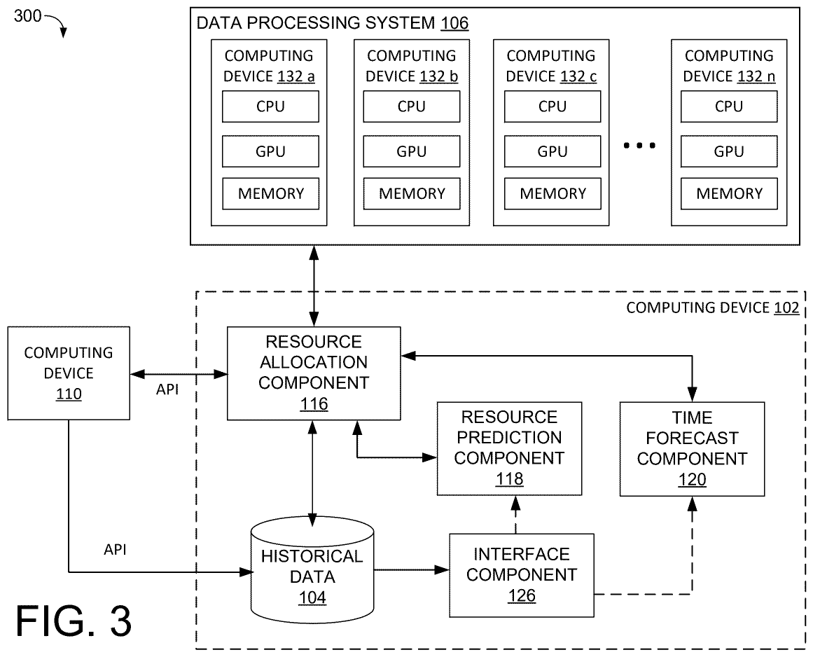

The interface component 126 may be configured to be in electronic communication with historical data store 104 to enable the computing device 102 to obtain and extract data from historical data store 104. In some embodiments, historical data store 104 may be an external data store containing historical data of system 100. In other embodiments, the computer-readable memory 114 may include the historical data store 104 (see e.g., FIG. 3). For example, in some embodiments, the interface component 126 may query and obtain data from historical data store 104 and provide the data to the resource prediction component 118 to enable prediction of computing resources to fulfill pipeline requests based on the historical data. In another example, the interface component 126 may provide the historical data from historical data store 104 to the time forecast component 120 to enable predicting time periods to execute the pipeline requests based on the historical data, as will be further described herein. That is, one or more components of computing device 102 may cooperate with interface component 126 to obtain the historical data of interface component 126 to perform the operations in accordance with the present disclosure.

The one or more components of computing device 102 may be communicatively and/or operably coupled to one another to perform one or more functions of the system 100. Each of the components of the system 100 may be communicatively coupled to one another via the communication component 124. In addition, each of the components of computing device 102 may be communicatively or operatively coupled to one another via bus 128.

The historical data store 104 may include historical data associated with previous pipeline requests performed on system 100 for user(s). The historical data store 104 may also include any of a plurality of other data including, but is not limited to, historical request data, user data, future pipeline requests (e.g., pipelines scheduled to be performed on system 100), classification data, other types of data, or any combinations thereof. This data may be utilized by computing device 102 to enable predicting computing resources and to orchestrate processing pipeline requests between computing device 102, data processing system 106, and/or computing device 110. For example, the historical data store 104 may include historical request data associated with a user that is now submitting a present pipeline request, the historical request data corresponding to historical pipeline requests from the user and including data corresponding to, for example, processing resources requested, processing resources utilized to fulfill the historical request, type of processing pipeline request, priority, dependencies, and other like data.

As used herein, the term “data processing pipelines,” “pipelines,” “pipeline requests,” “pipeline jobs,” etc., refers to a data processing task(s) that may be performed in series or in parallel utilizing one or more types of computing resources (e.g., CPU resources, GPU resources, memory resources, and other like resources). Each step or task may utilize a certain number of each type of computing resource and may produce an output when the pipeline is complete or may be an input to one or more next steps in the pipeline.

The pipeline may include one or more processing tasks to be performed on data of system 100. In some embodiments, the pipelines may be processing tasks performed on data associated with an online entity, that is, the data may be online transaction data associated with the online entity. For example, the online entity may be a financial entity and the data on system 100 may include online transaction data between one or more online merchants and one or more other users (e.g., customers of the online merchants). The online transaction data may include, but is not limited to, user data (e.g., users performing online transactions using system 100), account data, metadata, third-party services or third-party systems data, timestamp data, domain data, geographic location data, transaction outcome data (e.g., transaction completed, retracted, canceled, disputed, etc.), other like data, or any combinations thereof. For example, the pipeline may be configured to perform processing tasks on the transaction data to identify accounts engaging in fraudulent online transactions. In another example, the pipeline may be engineered to perform processing tasks to identify patterns associated with retracted transactions by users conducting in online transactions.

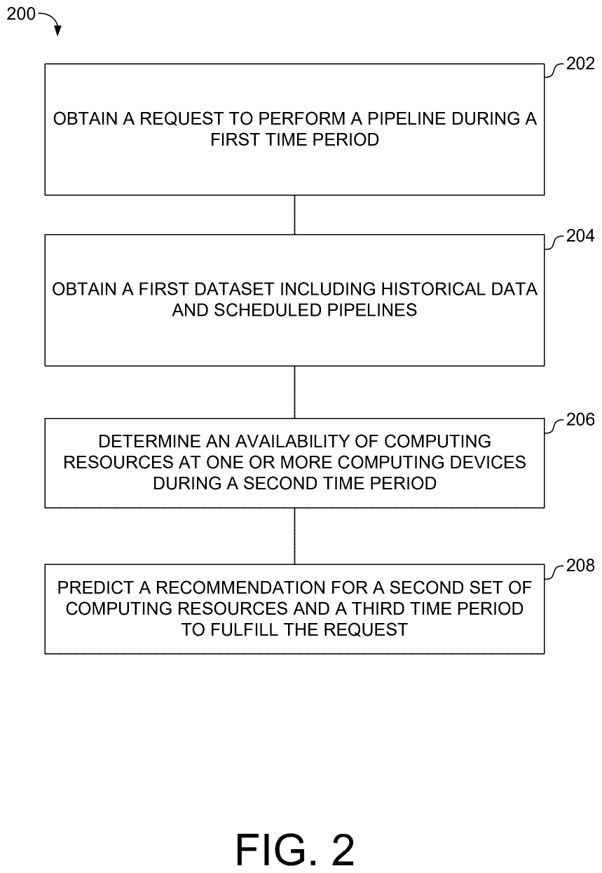

FIG. 2 is a flow diagram illustrating a method 200 of predicting computing resources to fulfill pipeline requests, according to some embodiments. The method 200, or one or more portions thereof, may be performed by resource allocation component 116 in conjunction with resource prediction component 118 and time forecast component 120, and may thus be computer-implemented.

FIG. 3 is a diagrammatic view of a system 300 including the computing device 102 and data processing system 106 of FIG. 1, according to some embodiments. The method 200 will be described in conjunction with the system 300.

At 202, the method 200 includes obtaining, at a first computing device from a second computing device, a request to perform a processing pipeline, the request defining a first set of computing resources for allocation during a first time period by the first computing device to fulfill the request. The first set of computing resources may be computing resources of one or more third computing devices to be allocated by the first computing device to fulfill the request. In FIG. 3, the request is shown as being obtained by resource allocation component 116 of computing device 102 from computing device 110. In addition, the data processing system 106 is shown in FIG. 3 as including the third computing device 132a, 132b, 132c, through 132n, which may hereinafter be referred to as third computing devices 132. In some embodiments, the third computing devices 132 may also be referred to as nodes, computing nodes, processing nodes, processing devices, processing units, and the like.

The first set of computing resources may define one or more different types of computing resources to be allocated from third computing devices 132 to fulfill the data processing pipeline request. The first set of computing resources may define a CPU resource 134, a GPU resource 136, a memory resource 138, or any combinations thereof, of the third computing devices 132 to allocate to the pipeline request. In some embodiments, the first set of computing resources may define the number of CPU resources 134 to allocate to fulfill the request. In other embodiments, the first set of computing resources may define the number of GPU resources 136 to allocate to fulfill the request. In yet other embodiments, the first set of computing resources may define a size of the memory resources 138 to allocate to fulfill the request.

Although FIG. 3 shows each of the third computing devices 132 in data processing system 106 includes CPU resource 134, GPU resource 136, and memory resource 138, it is to be appreciated by those having skill in the art that the third computing devices 132 may include one or more of these different resource types therein. For example, in some embodiments, third computing devices 132a may include therein CPU resource 134 and memory resource 138, and third computing devices 132b may include therein GPU resource 136. It is also to be appreciated by those having skill in the art that the CPU resource 134 may include a plurality of CPU cores, the GPU resource 136 may include a plurality of GPU cards, and the memory resource 138 may include a plurality of non-transitory computer readable memory.

Each third computing devices 132 may include therein one or more nodes for performing processing tasks, according to some embodiments. In some embodiments, the third computing devices 132 may be in electronic communication with one or more nodes, each node including CPUs for fulfilling data processing tasks. For example, each of the third computing devices 132 may be in electronic communication with nodes including a certain number of CPU resources and/or memory resources and nodes including a certain number of GPU resources for fulfilling graphics processing tasks.

The first time period may correspond to a time period, which is defined by a user such as, for example, a user associated with computing device 110, during which the processing resources of data processing system 106 are being requested at computing device 102. In some embodiments, executing/fulfilling the request may include orchestrating the request in cooperation with data processing system 106 based on the available resources and based on the first time period to thereby perform the processing tasks in the pipeline request until the tasks are completed. In some embodiments, the first time period may be a certain time period in a day. For example, the first time period may be defined as between 12-2 PM on a certain day. In other embodiments, the first time period may include one or more time periods in a day. For example, the first time period may be defined as being between 6-8 AM and 3-7 PM. In yet other embodiments, the first time period may include one or more days, that is, the first time period may provide the request be performed, for example, during a certain time interval (e.g., between 3-8 PM) during the time period (e.g., on each day for a period of days). For example, the first time period may be defined as performing the processing tasks between 8-10 PM each day over the next five days.

At 204, the method 200 includes obtaining a first dataset corresponding to historical data and scheduled pipelines. The first dataset may be extracted from a data store based on the request. The historical data may include user data, job data, historical job data (including requested computing resources and timestamp data), historical resource availability data, pipeline job types, actual computing resource utilization data, priority data, dependencies, other like data associated with pipeline job requests, or any combinations thereof. In some embodiments, the historical data may correspond to at least one of user ID data, pipeline ID data, pipeline duration data, pipeline code data, requested computing resources data, utilized computing resources data, timestamp data, priority data, dependencies data, and other like data. The user ID data may include a unique identifier (e.g., numeric code, alphanumeric code, etc.) of a certain length associated with the user submitting the pipeline request. For example, the user ID may be the employee code associated with the user. The pipeline ID may include a unique identifier (e.g., numeric code, alphanumeric code, etc.) of a certain length associated with the pipeline request or historical pipeline request. The pipeline code or pipeline code data may be the code associated with the pipeline request and defining the parameters of the pipeline request such as, for example, the requested processing resources and time period being requested for fulfilling the request. The computing resources data may include the processing resources being requested for fulfilling the request. For example, the computing resources data may include the resources in the pipeline request defined by the user, the resources that were actually utilized to fulfill the pipeline request, the time period each of the resources were utilized, and other like data. For example, the computing resources data may show that a certain request from the user requested 100 CPUs, 75 GPUs, and 50 GB of memory, whereas 50 CPU, 25 GPU, and 50 GB of memory was utilized to fulfill the request from the user. When fulfilling the pipeline request, the pipeline request may include a plurality of processing tasks, which may be run consecutively, concurrently, or any combinations thereof. For example, many of the processing tasks may be performed concurrently at different nodes, while other processing tasks may have dependencies that necessitate being performed consecutively. In some embodiments, some of the processing tasks may be dependent on the completion of certain other processing tasks. For example, certain processing tasks may be dependent on the output from other processing tasks as input prior to being able to be performed. The historical data may include data corresponding to these dependencies.

The historical data is shown as being obtained from historical data store 104 in FIG. 3. In some embodiments, the historical data store 104 may be stored in the computer-readable memory such as, for example, computer-readable memory 114 of FIG. 1. In other embodiments, the historical data may be queried and obtained from historical data store 104 and stored on computer-readable memory 114.

At 206, the method 200 includes determining an availability of computing resources at one or more third computing devices during a second time period. That is, in FIG. 3, the computing resources available at the one or more third computing devices 132 in data processing system 106 may be determined by computing device 102. The availability determination may be based on pipeline jobs currently being performed by the third computing devices 132 and may be based on future scheduled jobs (and corresponding allocated resources) to be performed by the third computing devices 132.

The computing device 102 may determine the computing resources that are available at each of the third computing device 132a, third computing devices 132b, third computing devices 132c, etc., during the second time period and may orchestrate pipeline request fulfillment based on the availability. That is, the computing device 102 may dynamically utilize available computing resources at each computing device of the one or more third computing devices 132 to fulfill processing tasks for pipelines requested by second computing devices 110. In some embodiments, the computing device 102 may determine the total computing resources available at data processing system 106, that is, for all third computing devices 132 collectively in data processing system 106 for the second time period. In other embodiments, the computing device 102 may send a request for the available computing resources at the third computing devices 132 to data processing system 106 and the data processing system 106 may return a report to computing device 102 detailing the available computing resources at the third computing devices 132 in data processing system 106 in response to the request.

The second time period may include therein the first time period, that is, the second time period may be greater than the first time period. In this regard, the computing device 102 may determine an availability of the computing resources at data processing system 106 for a time period greater than the first time period to enable the computing device 102 to identify one or more time periods (e.g., third time periods) during which the request may be fulfilled by the data processing system 106. For example, the request may define the first time period as being during a few hours of the day, and the second time period may include the entire day to enable the computing device 102 to identify one or more time periods during the day where the data processing system 106 has the resources available to fulfill the request.

Operations 204, 206 may be performed substantially in parallel, such that the computing device 102 can determine resource availability at the data processing system 106 and obtain the historical data store 104 to enable performing the other operations of method 200.

The computing device 102 may include one or more models leveraged by computing device 102 (i.e., resource prediction component 118 and time forecast component 120) to determine the computing resource availability at data processing system 106 and to predict optimal time periods to fulfill requests. In addition, the computing device 102 may utilize the model to apply one or more techniques to extract data from a data store such as, for example, the historical data store 104 based on the request. For example, the model may extract, based on the request and the scheduled jobs in system 100, user data of the user associated with computing device 110, historical pipeline jobs submitted by the user, actual computing resource utilization for the historical pipeline jobs of the user, future scheduled jobs from one or more other users, and other like data.

At 208, the method 200 includes predicting a second set of computing resources capable of fulfilling the request during one or more third time periods. The one or more third time periods may be determined based on, at least in part, the first time period as defined by the user and provided in the pipeline request, according to some embodiments. The one or more third time periods may also be determined based on the second time period, in some embodiments. That is, both the first time period and the one or more third time periods may fall within the second time period-the first time period being a preferred time of the user for performing the pipeline request using the defined processing resources and the one or more third time periods being one or more predicted/recommended time periods that may fall within the second time period for performing the pipeline request based on the predicted processing resources for fulfilling the request as determined by the models. In some embodiments, the one or more third time periods may also fall outside the second time period. For example, the third time periods may be a prediction/recommendation for fulfilling a certain processing task of a user and the processing task may be configured to run at periodic intervals (e.g., once a week), the intervals thereby extending beyond the second time period.

The prediction of the second set of computing resources may be determined based on the first dataset and the availability of the one or more computing resources in the third computing devices. For example, the request may define 100 CPU cores and 150 GB of memory for fulfilling a processing task and the computing device 102 may determine the resource utilization throughout the day and provide a recommendation, based on the request and the predicted utilization, that 50 CPU cores and 100 GB of memory can fulfill the processing request. In some embodiments, the model may predict the second set of computing resources capable of fulfilling the request and may also determine the one or more third time periods during which the data processing system 106 may fulfill the request. In some embodiments, the one or more third time periods may be based on the first dataset (from historical data store 104) and based on the computing resource availability at data processing system 106. That is, the computing device 102 may determine the computing resource availability for the second time period at data processing system 106 to then determine the one or more third time periods to recommend for fulfilling the request. That is, in some embodiments, the second time period may be determined based on the first time period (e.g., n minutes, hours, days, etc. therefrom) and the third time periods may be determined based on the determined second time period. For example, the request may define 150 GPU cards for performing the pipeline request during a peak utilization time window (e.g., first time period) of system 100, and the computing device 102 may predict, based on historical data for similar historical job types from the user and based on the currently scheduled processing jobs and resource availability for the day, week, month, quarter, etc. (e.g., second time period), that the request can be fulfilled using 75 GPU cards in corresponding third computing devices 132 of data processing system 106 and during an off-peak time window (e.g., third time period) when the resources in data processing system 106 are available to fulfill the task.

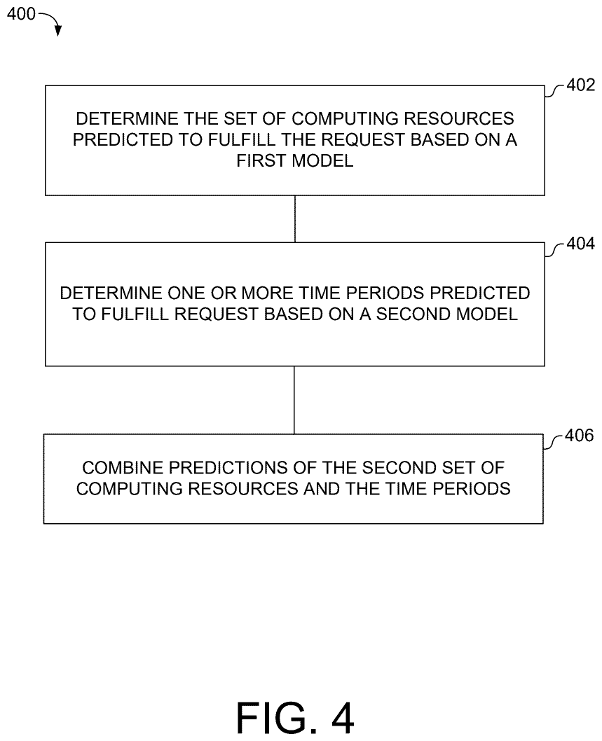

FIG. 4 is a flow diagram illustrating a method 400, according to some embodiments. The method 400 may be an embodiment of operation 208, 210, according to some embodiments.

At 402, the method 400 includes determining the second set of computing resources predicted to fulfill the request based on application of a first model to the first dataset. For example, the second set of computing resources may be determined based on the first model applying one or more techniques to data including user data, historical job data, and the like.

At 404, the method 400 includes determining the one or more third time periods predicted to fulfill the request based on application of a second model to the first dataset. For example, the third time periods may be determined based on the second model applying one or more techniques to data including user data, historical job data, resource availability data, scheduled jobs, and the like.

At 406, the method 400 may include combining the prediction of the second set of computing devices and the one or more third time periods. In some embodiments, combining the predictions from the first model and the second model may include applying a weighting to the predictions from the first model and the prediction of the second model. The first model and second model may provide as output one or more predictions or sets of predictions and may be adjusted at each iteration based on one or more factors. The weighting may be applied to each prediction or set of predictions from the first and second models and combined to determine a score for the prediction of the second set of computing resources and the prediction for the third time periods. Combining the predictions may also include combining scores using the weighted average of the predictions and providing the pipeline and its combined score to the second dataset provided as output. In some embodiments, combining the predictions may include sorting the predictions by the combined score, and returning the top-k recommendations, that is, the predictions included in the second dataset may be based on the top-k recommendations.

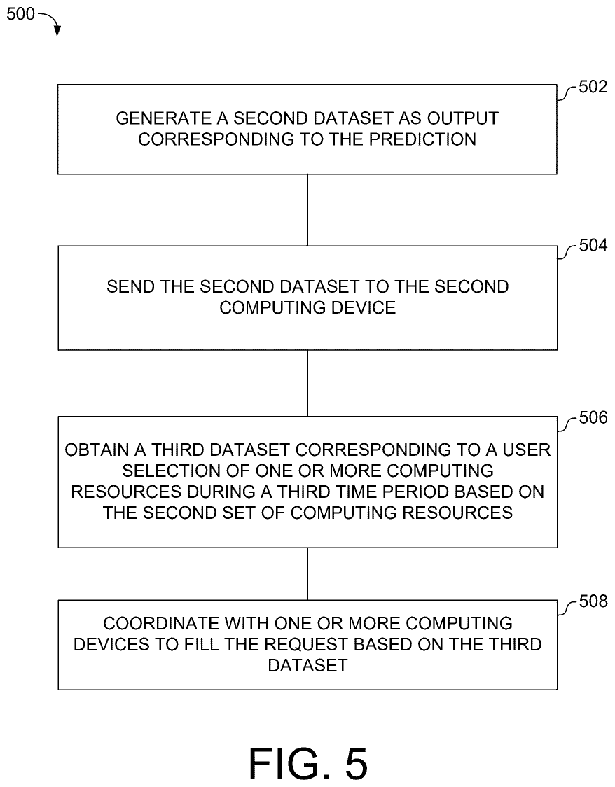

FIG. 5 is a flow diagram illustrating a method 500, according to some embodiments. The method 500, or one or more portions thereof, may be performed by computing device 102 in conjunction with data processing system 106 and computing device 110, and thus may be computer-implemented.

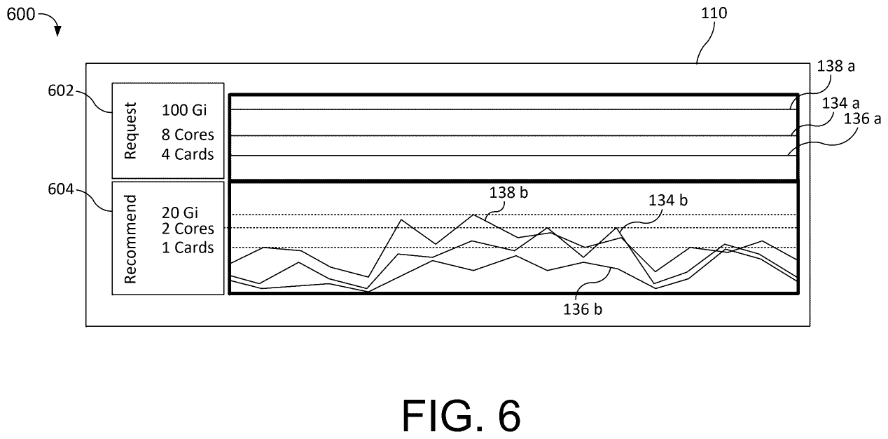

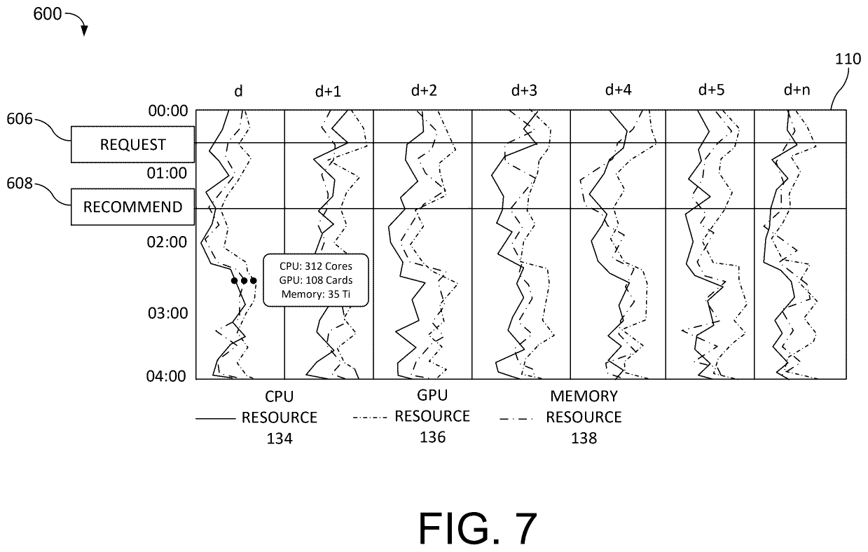

FIG. 6 is a graphical illustration of a non-limiting example of a user interface 600, according to some embodiments. FIG. 7 is a graphical illustration of another non-limiting example of the user interface 600, according to some embodiments. The method 500 will be described in conjunction with FIGS. 5 and 6.

At 502, the method 500 includes generating a second dataset as output corresponding to the prediction. The second dataset may include the second set of computing resources and the third time period. In some embodiments, the second dataset may include one or more third time periods.

At 504, the method 500 includes sending the second dataset to the second computing device. In FIG. 6, the second dataset may be shown on user interface 600 such as, for example, a display of computing device 110 and may include data corresponding to the request 602 and data corresponding to the recommendation 604 (i.e., prediction). The request 602 may include graphical data providing a visual indication of the computing resources provided in the request 602 obtained by computing device 102 from computing device 110. The recommendation 604 may include graphical data providing a visual indication of the computing resources predicted to be needed to fulfill the pipeline request. The request 602 and recommendation 604 may also include the prediction of the computing resources to fulfill the pipeline request, that is, the CPU resource 134, GPU resource 136, memory resource 138, or any combinations thereof. For example, as shown in FIG. 5, the request provides for 8 CPU cores, 4 GPU cards, and 100 GBs of memory, while the recommendation provides for 2 CPU cores, 1 GPU card, and 20 GBs of memory.

The prediction of the computing resources may include the resource usage over the time period estimated to be needed to fulfill the request. In this regard, the predicted computing resource may be determined based on the resource needs over the time period to fulfill the request. In some embodiments, the prediction may be an average of the particular resource utilization over the time period. In other embodiments, the prediction may be determined based on a maximum of the resource usage over the time period. For example, the number of computer cores to handle the pipeline request is predicted to be 2 CPU cores as the maxima CPU resource usage during the time period is predicted to be 2 CPU cores.

It is to be appreciated by those having skill in the art that although the computing resource prediction shown in FIG. 6 includes CPU resource 134, GPU resource 136, and memory resource 138, the resources shown by user interface 600 is not intended to be limiting and may include fewer types of computing resources or additional types of computing resources in accordance with the present disclosure.

At 506, the method 500 includes obtaining a third dataset corresponding to a user selection of one or more computing resources during a third time period based on the second set of computing resources. In some embodiments, the second dataset may include one or more third time periods and the user selection may include a third period of the one or more third time periods. In FIG. 6, user interface 600 may include request 602. The request 602 may include a graphical representation of computing resources, that is, CPU resource 134a, GPU resource 136a, and memory resource 138a, included in the pipeline request that is obtained by computing device 102 from computing device 110. User interface 600 may include recommendation 604. Recommendation 604 may include a graphical representation of computing resources, that is, CPU resource 134b, GPU resource 136b, and memory resource 138b, predicted to be needed to fulfill the request 602. The user interface 600 may also include the time period predicted to fulfill the pipeline request. In this regard, the request 602 and recommendation 604 may include the computing resource utilization over the time period to perform the pipeline request.

In response to request 602, the second dataset may include one recommendation 604. In some embodiments, the second dataset may include one or more recommendations 604. Each recommendation 604 displayed on user interface 600 may include a set of computing resources. Each recommendation 604 may also include the time period for fulfilling the pipeline request. When the second dataset includes a plurality of recommendation 604, each recommendation 604 may include a combination of computing resources predicted to fulfill the pipeline request and a time period based on the combination of computing resources. The combination of computing resources and predicted time period to fulfill the request 602 may vary per recommendation 604 based on one or more factors of system 100 such as, for example, the resources being allocated to fulfill the job and the available resources at the data processing system 106 during the time period. For example, time period to fulfill the request may vary based on more or less computing resources being allocated to the request 602.

Pipeline requests may be configured to run one or more times. In some embodiments, a pipeline request may be configured to be performed periodically over a period of time. For example, the pipeline request may be configured to be performed once a day. In another example, the pipeline request may be configured to be performed once a week, bi-weekly, monthly, etc. Based on such a request, the second dataset may include a recommendation that is provided based on a plurality of factors including, but not limited to, user historical data, computing resource utilization (e.g., past jobs and future jobs), requested computing resources, predicted computing resources, time period to fulfill the request, other factors, or any combinations thereof.

In FIG. 7, the user interface 600 displays request 606 over a period of time that spans between d to d+n days. The request 606 may include the requested time period during the day when to perform the pipeline. The user interface 600 may also display recommendation 608 over the same time period. The request 606 may include a predicted time period during the day for performing the pipeline. The predicted time period may be based on the predicted computing resources needed to fulfill the pipeline. The time period to execute and fulfill one pipeline request of a series of pipeline requests may also be based on the estimated utilization of the computing resources over an extended time period (e.g., days, weeks, months, years, etc.) that the pipeline is to be performed. For example, the request 606 may be based on the time of day that is predicted to have the lowest resource utilization in data processing system 106, that is, when the most computing resources of data processing system 106 are available on each day the request is to be performed over the d+n days.

The second dataset may include one or more recommendation 608 that may be displayed on the user interface 600. For example, the second dataset may include two, three, or more recommendations for when to perform the pipeline request over the period of d+n days.

At 508, the method 500 includes coordinating with the one or more third computing device to fulfill the request based on the third dataset. The third dataset may correspond to a user selection of the recommendation 608. For example, as shown in FIG. 7, the user of computing device 110 may use an input device (e.g., mouse) to hover over different time periods (e.g., days and hours) and the user interface 600 may display information corresponding to the resource utilization during that time. With the input device, the user of computing device 110 may also hover over recommendation 608 and user interface 600 may display the predicted resource utilization to fulfill the request. The user may also select recommendation 608 using the input device, and the user interface 600 may receive the input and generate the third dataset to be sent to computing device 102 to enable orchestration of the pipeline request.

When one or more of the recommendations 608 are shown on user interface 600, the third dataset may include the user selection of one of the recommendations 608. In some embodiments, the third dataset may correspond to a user selection of request 606. In other embodiments, the third dataset may correspond to a user selection of some other combination of computing resources and time period other than request 606 or recommendation 608.

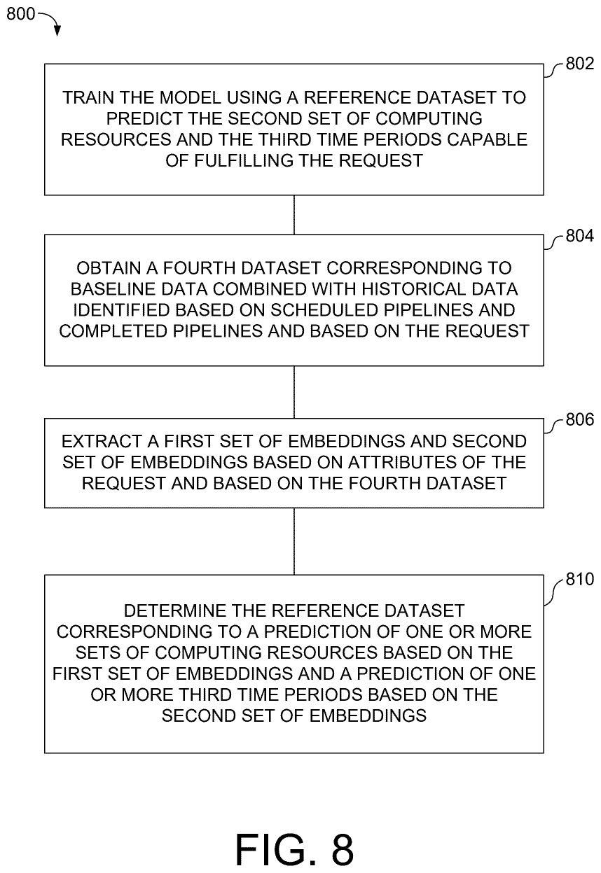

FIG. 8 is a flow diagram of a method 800, according to some embodiments. The method 800, or one or more portions thereof, may be performed by the resource allocation component 116 in conjunction with the resource prediction component 118 and time forecast component 120, and thus may be computer-implemented.

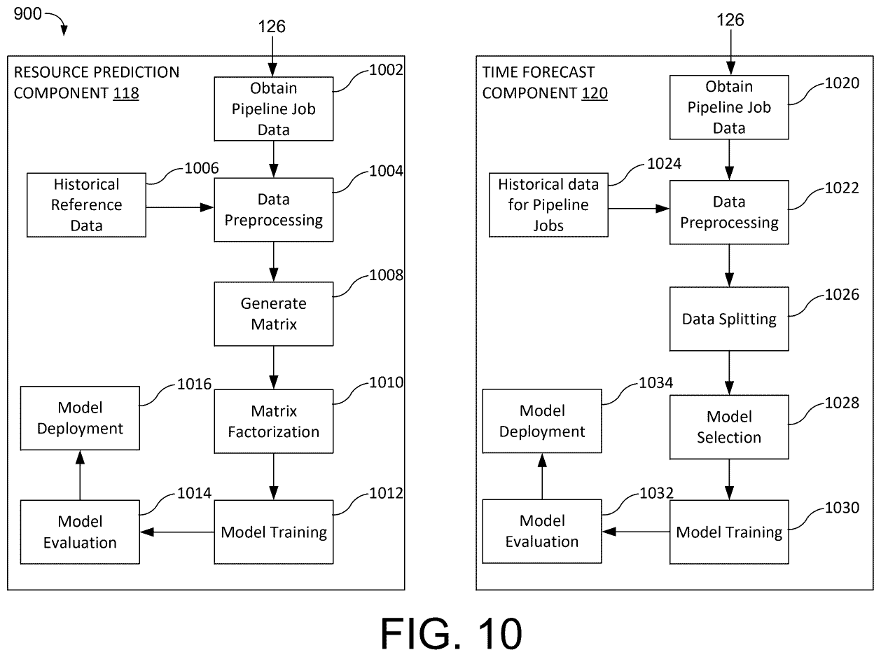

At 802, the method 800 includes training a model using a reference dataset to enable predicting the second set of computing resources and the third time periods capable of fulfilling the request. The computing device 102 may include the model utilized by the resource prediction component 118 and time forecast component 120 (see FIG. 10).

At 804, the method 800 includes obtaining a fourth dataset corresponding to a baseline dataset combined with historical data identified based on the scheduled pipelines and completed pipelines and based on attributes of the request. The scheduled requests may be pipeline jobs that are queued (e.g., pending) and waiting until the scheduled time period to begin. In addition, the scheduled requests become completed jobs as they are fulfilled, which may also be obtained as part of the fourth dataset.

The fourth dataset may include historical data. The historical data may be associated with the obtained scheduled and completed pipeline jobs. The historical data may be extracted from the historical data store 104 based on the listing (e.g., queue) of completed and scheduled pipeline jobs. The obtained historical data may include, for example, user data, pipeline job data, pipeline request types, processing task types, requested computing resources, actual computing resource utilizations, timestamp data (e.g., job duration), metadata, job priority, size data, cost consideration data, and other like data. In some embodiments, the historical data may be for one or more users (e.g., ML engineers and/or data scientists) of the system. In other embodiments, the historical data may be for the user associated with the computing device submitting the request. For example, the fourth dataset may include completed pipeline jobs of the user submitting the request and the scheduled pipeline jobs for all the users of the system.

At 806, the method 800 includes extracting a first set of embeddings and second set of embeddings based on attributes of the request and based on the fourth dataset.

At 810, the method 800 includes determining the reference dataset corresponding to a prediction of one or more sets of computing resources based on the first set of embeddings and a prediction of one or more third time periods based on the second set of embeddings. In this regard, the model may be trained using the reference dataset and utilized in a live production environment for predicting computing resources and time periods for fulfilling pipeline jobs. The model may include a previous iteration model trained using a baseline dataset (e.g., historical pipeline job data) and the reference dataset (e.g., user-submitted pipeline jobs and completed pipelines), that is, when new requests are obtained, the obtained data may be processed and analyzed using the model to generate the reference dataset and combined with the baseline data to iteratively train the previous iteration model to enable improved prediction capabilities using live data.

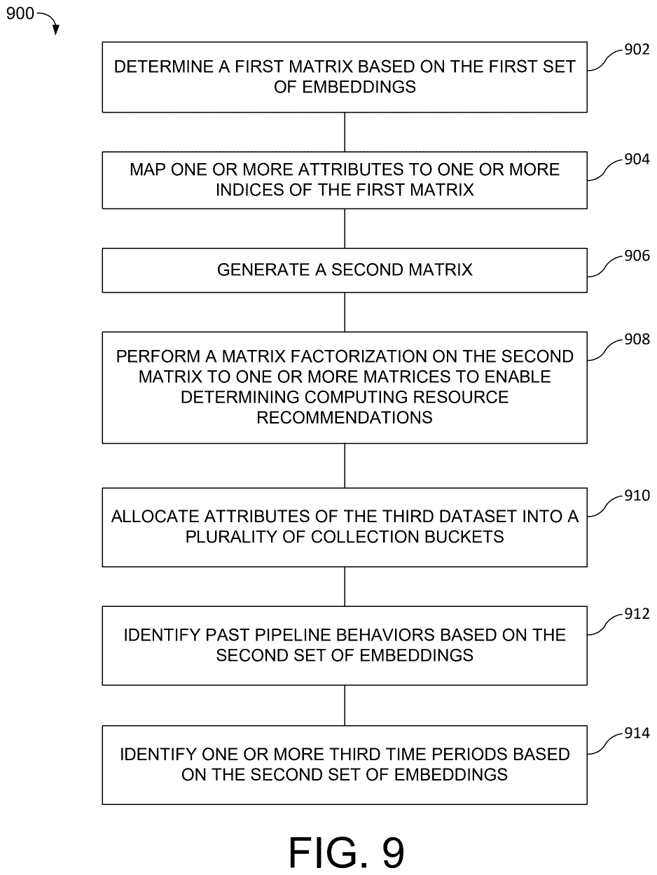

FIG. 9 is a flow diagram of a method 900, according to some embodiments. The method 900, or one or more portions thereof, may be embodiments of operations 804, according to some embodiments.

FIG. 10 is a diagrammatic view of a system 1000 for performing the method 900, according to some embodiments. The method 900 will be described in conjunction with system 1000.

At 902, the method 900 includes determining a first matrix based on the first set of embeddings. As shown in FIG. 10, at block 1002 and 1020, a listing of the scheduled and completed pipeline jobs may be obtained by the resource prediction component 118 and time forecast component 120, respectively, via interface component 126. The interface component 126 may enable interfacing with the historical data store 104 to obtain the scheduled and completed jobs, as shown in FIG. 3. In this regard, the resource prediction component 118 and time forecast component 120 leverages the models with real-time data and user-specific insights to make intelligent computing resource recommendations. In FIG. 10, at block 1004, the data from blocks 1002, 1006 may be obtained and processed (e.g., preprocessed) to extract the first set of embeddings. In addition, at block 1022, the data from blocks 1020, 1024 may be obtained and processed (e.g., preprocessed) to extract the second set of embeddings.

At 904, the method 900 includes mapping one or more attributes to one or more indices of the first matrix. In FIG. 10, at block 1008, the techniques may include determining a user-pipeline matrix based on extracted embeddings from the user-submitted jobs. The resource prediction component 118 obtains the data from block 904 such as, for example, User ID, pipeline Job ID, job duration, computing resource utilization, pipeline tasks code, requested computing resources (e.g., CPU, GPU, and memory), and other like attributes as features for the technique.

At 906, the method 900 includes generate a second matrix based on the mapping. In FIG. 10, at block 1008, the second matrix may be a user-item interaction matrix. Creating the user-item interaction matrix may include creating empty arrays to store row indices, column indices, and data values, determining one or more attributes as values based on user preferences (e.g., CPU resource 134, GPU resource 136, and memory resource 138), and produce the user-item interaction matrix as output. The user-item interaction matrix may be a sparse matrix, according to some embodiments. In addition, the sparse matrix may be created using coordinate frame (“COO”) format, in some embodiments.

At 908, the method 900 includes perform a matrix factorization on the second matrix to one or more matrices to enable the model to determine computing resource recommendations. The matrix factorization enables the model to determine user preferences and pipeline characteristics based on weightings associated with the computing resources to make predictions in response to the request. In FIG. 10, at block 1010, the techniques can include a matrix factorization (e.g., Singular Value Decomposition (SVD)) or deep learning approach (e.g., neural collaborative filtering) to capture user preferences and pipeline characteristics, allowing the model to make recommendations based on historical user behavior data. In some embodiments, the matrix factorization may include obtaining a dataset with attributes from historical data and/or the user-submitted job, mapping the user and pipeline job IDs to matrix indices, generate a user-item interaction matrix based on the attributes, perform SVD on the user-item interaction matrix, determine and recommend the optimal CPU, GPU, and timeslot based on user preferences.

Performing the SVD on the user-item interaction matrix may include performing the SVD to factorize the matrix into three matrices and producing a diagonal matrix from the singular values as output. Determining and recommending the optimal CPU, GPU, and timeslot based on user preferences may include predicting user-item interactions based on the three matrices, determining scores for the predicted CPU resource 134, GPU resource 136, memory resource 138, and/or job duration scores, and determining the optimal computing resources and time period to fulfill the request based on the scores. For example, the computing resources and time period may be selected based on the scores.

At 910, the method 900 includes allocate the attributes of the third dataset into a plurality of collection buckets based on a classification. In FIG. 10, the time forecast component 120 leverages the historical time-ordered data to identify broader resource demand patterns over time to enable predicting optimal pipeline fulfillment time periods for orchestrating pipelines. In this regard, the time forecast component 120, at block 1022, may apply the one or more techniques to enable training the model to predict future trends, patterns, or resource demands based on past usage behaviors and to enable determining optimal time periods for performing user-submitted pipeline requests. The one or more techniques may be applied to data including timestamps, job durations, computing resource utilizations, processed data size (e.g., memory), priority, user IDs, job IDs, historical job data, system load metrics, seasonal factors (e.g., calendar events affecting usage), dependencies, cost considerations, other like data, or any combinations thereof. At block 1026, the techniques may include data splitting may include allocating the obtained data from block 922 and block 924 to one or more data columns based on a classification of the data.

At 912, the method 900 includes identify past pipeline behaviors based on the second set of embeddings. At block 1028, the techniques may include identifying and selecting one or more models to predict the time period to fulfill the pipeline request based on the predicted computing resource utilizations (e.g., CPU resource 134 usage, GPU resource 136 usage, etc.), identifying the time period with the lowest CPU usage (e.g., time of day or common time period over one or more days), and provide as output the optimal time period for performing the pipeline request based on the usage data. In some embodiments, the time forecast component 120 may apply the one or more models to predict optimal time periods for each of the CPU resource 134 and the GPU resource 136.

At 914, the method 900 includes identifying, based on computing resource utilization at the one or more third computing devices, one or more third time periods based on the second set of embeddings. The one or more third time periods are determined based on the second set of embeddings.

In FIG. 10, at blocks 1014, 1032, the model performance may be evaluated prior to deployment. The evaluation may include comparing the predicted resource demand with the actual resource utilization and timestamp data for the predicted time duration and actual time duration to obtain feedback on the effectiveness of the recommendations and resource allocations. In some embodiments, the feedback may include one or more user inputs obtained from a user interface such as, for example, user interface 600 corresponding to the performance of the model. This evaluation and feedback data may be obtained by the resource prediction component 118 and time forecast component 120, respectively, and may be used to refine the recommendation and allocation techniques and processes performed by resource prediction component 118 and time forecast component 120 using the models.

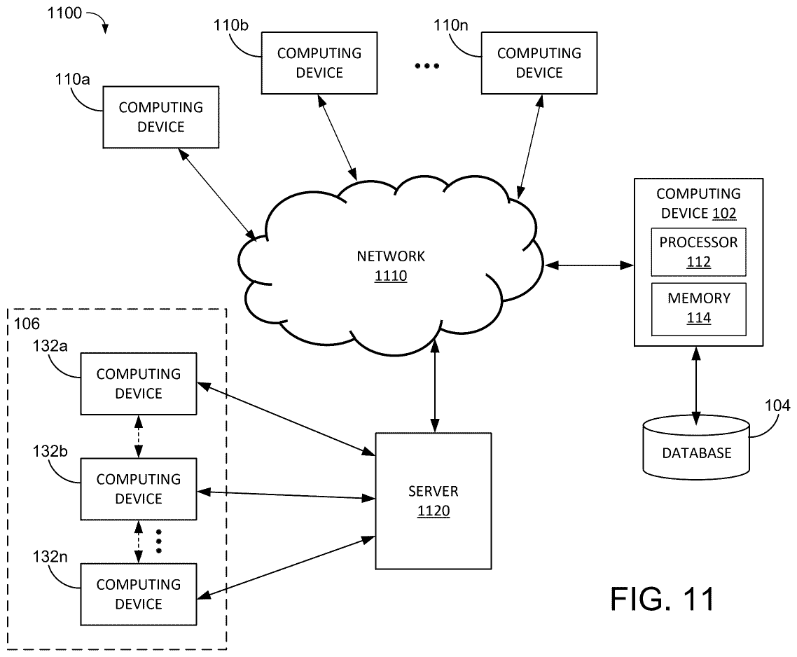

FIG. 11 is a block diagram illustrating a network-based system 1100, according to some embodiments.

Not all of these components may be required to practice one or more embodiments, and variations in the arrangement and type of the components may be made without departing from the spirit or scope of various embodiments of the present disclosure. In various embodiments, the network-based system 1100 may include the computing device 102 of FIG. 1. The computing device 102 may be in communicable connection with a network 1110 to send and receive information corresponding to one or more datasets with one or more other computing devices. The one or more computing devices may include, for example, computing device 110a, computing device 110b, and through computing device 110n (hereinafter referred to as computing device 110). In network-based system 1100, the computing devices 110 may be associated with users sending pipeline jobs to computing device 102 and/or to system 100 as shown in FIG. 1. The one or more computing devices may also include, in another example, computing device 132a, computing device 132b, and through computing device 132n (hereinafter referred to as computing device 132). In network-based system 1100, the third computing devices 132 may correspond to computing devices for performing the processing tasks to fulfill the pipeline requests as sent to data processing system 106 as shown in FIG. 1.

The computing devices 132 may be in communicable connection with the computing device 102. In some embodiments, the third computing devices 132 may be in communicable connection with one or more computing devices through network 1110 and/or through server 1120. In some embodiments, the one or more other computing devices 132 may be a computerized tool (e.g., any suitable combination of computer-executable hardware and/or computer-executable software) which can be configured to perform the one or more processing tasks in accordance with the present disclosure. For example, in some embodiments, the data processing system 106 in FIG. 1 may include one or more of the third computing devices 132, each third computing device 132 having at least one of CPU resources 134, GPU resources 136, and/or memory resources 138 therein to perform the pipeline processing tasks orchestrated by computing device 102. In some embodiments, each of the third computing devices 132 may be a node or may include a cluster of nodes for performing different types of tasks including, but not limited to, processing data using the CPU resources 134, performing graphical processing tasks using GPU resources 136, and storing and copying data based on the operations of the CPU resource 134 and GPU resource 136 using memory resources 138.

In some embodiments, computing device 102 and computing devices 132 may be any type of processor-based platforms that are connected to network 1110 such as, without limitation, servers, personal computers, digital assistants, personal digital assistants, smart phones, pagers, digital tablets, laptop computers, Internet appliances, cloud-based processing platforms, and other processor-based devices either physical or virtual. In some embodiments, the computing device 102 and third computing devices 132 may be specifically programmed with one or more application programs in accordance with one or more principles/methodologies detailed herein. In some embodiments, the computing device 102 may be specifically programmed with the resource allocation component 116, resource prediction component 118, and time forecast component 120 to leverage one or more machine learning models or neural network models in accordance with one or more principles/methodologies detailed herein. In some embodiments, the computing device 102, computing devices 110, and computing devices 132 may operate on any of a plurality of operating systems capable of supporting a browser or browser-enabled application, such as Microsoft™, Windows™, and/or Linux. In some embodiments, the computing device 102, computing devices 110, and computing devices 132 each may include at least include a computer-readable medium, such as a random-access memory (RAM) or FLASH memory, coupled to a processor.

In some embodiments, the computing device 102 and/or the third computing devices 132 shown may be accessed by, for example, the computing devices 110 by executing a browser application program such as Microsoft Corporation's Internet Explorer™, Apple Computer, Inc.'s Safari™, Mozilla Firefox, and/or Opera to obtain data from the network 1110. In some embodiments, the computing devices 110 may communicate over the exemplary network 1110 with the computing device 102 to obtain predictions for the computing resources needed to fulfill pipeline jobs and the time period predictions, and which may be provided to computing devices 110 based on computing resource availability at computing devices 132.

In some embodiments, the network-based system 1100 may include at least one data store 104. The data store 104 may have stored thereon historical data corresponding to historical pipeline jobs and scheduled jobs in accordance with the present disclosure, including user data for one or more users of network-based system 1100. The data store 104 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

In some embodiments, the network-based system 1100 may also include and/or involve one or more cloud components. Cloud components may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.). In some embodiments, the computer-based systems/platforms, computer-based devices, components, media, and/or the computer-implemented methods of the present disclosure may be specifically configured to operate in or with cloud computing/architecture such as, but not limiting to infrastructure a service (IaaS), platform as a service (PaaS), and/or software as a service (SaaS).

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing device (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud components and cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux™, (2) Microsoft Windows™, (3) OS X (Mac OS), (4) Solaris™, (5) UNIX™ (6) VMWare™, (7) Android™, (8) Java Platforms™, (9) Open Web Platform, (10) Kubernetes or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

In some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-200, RTR0, SHA-1, SHA-2, Tiger (TTH), WHIRLPOOL, RNGs).

The machine learning models and/or neural network models as described in the various embodiments herein can be any suitable computer-implemented artificial intelligence algorithm that can be trained (e.g., via supervised learning, unsupervised learning, reinforcement learning, generative learning) to receive input data and to generate output data based on the received input data (e.g., neural network, linear regression, logistic regression, decision tree, support vector machine, naive Bayes, and/or so on). In various aspects, the input data can have any suitable format and/or dimensionality (e.g., character strings, scalars, vectors, matrices, tensors, images, and/or so on). Likewise, the output data can have any suitable format and/or dimensionality (e.g., character strings, scalars, vectors, matrices, tensors, images, and/or so on). In various embodiments, the model(s) can be implemented to generate any suitable determinations and/or predictions in any suitable operational environment (e.g., can be implemented in a payment processing context, where the model receives payment data, transaction data, and/or customer data and determines/predicts whether given transactions are fraudulent, whether given customers are likely to default, and/or any other suitable financial determinations/predictions, and/or so on).

In some embodiments, a system includes a first computing device including a processor, and a memory including a non-transitory computer readable media having stored therein instructions executable by the processor to perform operations including obtain, from a second computing device, a request to perform a processing pipeline during a first time period, the request defining a first set of computing resources for allocation by the first computing device to fulfill the request, obtain, based on the request, a first dataset corresponding to historical data and scheduled pipelines, determine an availability of computing resources at one or more third computing devices during a second time period based on the request, and predict, by a model, a recommendation corresponding to a second set of computing resources and a third time period to fulfill the request, the prediction being determined based on the first dataset and the available computing resources at the one or more third computing devices.

In some embodiments, the processor further performs operations including generate a second dataset as output corresponding to the prediction, send the second dataset to the second computing device, obtain, in response to the second dataset, a third dataset corresponding to a user selection of one or more computing resources during a third time period based on the second set of computing resources, and coordinate with the one or more third computing devices to fulfill the request based on the third dataset.

In some embodiments, predicting the second set of computing resources and the third time period further includes determine the second set of computing resources predicted to fulfill the request based on applying a first model to the first dataset, determine one or more third time periods predicted to fulfill the request based on applying a second model to the first dataset, and combine predictions of the second set of computing resources and the one or more third time periods to generate the second dataset.

In some embodiments, the first dataset includes historical request data associated with one or more users identified based on attributes of the request from the second computing device.

In some embodiments, the first dataset includes historical request data associated with a user of the second computing device identified based on attributes of the request from the second computing device.

In some embodiments, the first computing device is capable of dynamically utilizing computing resources at each of the one or more third computing devices to fulfill processing tasks for one or more pipelines from one or more second computing devices.

In some embodiments, the processor further performs operations including train the model using a reference dataset to predict the second set of computing resources and the third time period capable of fulfilling the request.

In some embodiments, the processor further performs operations including obtain a fourth dataset corresponding to a baseline dataset combined with historical data identified based on the scheduled pipelines and completed pipelines and based on the request, extract a first set of embeddings and second set of embeddings based on attributes of the request and based on the fourth dataset, and determine the reference dataset corresponding to a prediction of one or more sets of computing resources based on the first set of embeddings and a prediction of one or more time periods based on the second set of embeddings.

In some embodiments, the historical data corresponds to at least one of a user ID data, pipeline ID data, pipeline duration data, pipeline code data, requested computing resources data, utilized computing resources data, timestamp data, priority data, and dependencies data.

In some embodiments, a computer-implemented method for using neural network models to predict available resources including obtaining, by a first computing device from a second computing device, a request to perform a processing pipeline, the request defining a first set of computing resources for allocation during a first time period by the first computing device to fulfill the request, obtaining, based on the request, a first dataset corresponding to historical data and scheduled pipelines, determining, by a neural network model, an availability of computing resources at one or more nodes during a second time period based on the request, determining, by the neural network model, a recommendation corresponding to a second set of computing resources and one or more third time periods to fulfill the request, the recommendation being based on the first dataset and the available computing resources at the one or more nodes, generate a second dataset as output corresponding to the prediction, sending the second dataset to the second computing device to obtain, in response to the second dataset, a third dataset corresponding to a user selection of one or more computing resources during a third time period of the one or more third time periods, and coordinating with the one or more nodes to fulfill the request based on the third dataset. In some embodiments, the first computing device is capable of dynamically utilizing computing resources at each of the one or more nodes to fulfill processing tasks for one or more pipelines from one or more second computing devices.

In some embodiments, predicting the second set of computing resources and the one or more third time periods further includes determining, by a first neural network model, the second set of computing resources predicted to fulfill the request based on the first dataset, determining, by a second neural network model, the one or more third time periods predicted to fulfill the request based on the first dataset, and combining predictions of the second set of computing resources and the one or more third time periods to generate the second dataset.

In some embodiments, the computer-implemented method further includes training the neural network model using a reference dataset to predict the second set of computing resources and the one or more third time periods capable of fulfilling the request.

In some embodiments, the computer-implemented method further includes obtaining a fourth dataset corresponding to a baseline dataset combined with historical data identified based on the scheduled pipelines and completed pipelines and based on the request, extracting a first set of embeddings and second set of embeddings based on attributes of the request and based on the fourth dataset, and determining the reference dataset corresponding to a prediction of one or more sets of computing resources based on the first set of embeddings and a prediction of one or more time periods based on the second set of embeddings. In some embodiments, the historical data corresponds to at least one of a user ID data, pipeline ID data, pipeline duration data, pipeline code data, requested computing resources data, utilized computing resources data, timestamp data, priority data, and dependencies data.

In some embodiments, extracting the first set of embeddings based on attributes of the request and based on the fourth dataset further includes determining a first matrix based on the first set of embeddings, mapping one or more attributes to one or more indices of the first matrix, generating a second matrix based on the mapping, and performing a matrix factorization on the second matrix to one or more matrices to enable the neural network model to determine computing resource recommendations. In some embodiments, the matrix factorization enables the neural network model to determine user preferences and pipeline characteristics based on weightings associated with the computing resources to make predictions in response to the request.

In some embodiments, extracting the second set of embeddings based on the attributes of the request and based on the fourth dataset further includes allocating the attributes of the third dataset into a plurality of collection buckets based on a classification, identifying past pipeline behavior based on the second set of embeddings, and identifying, based on computing resource utilization at the one or more third nodes, one or more third time periods based on the second set of embeddings. In some embodiments, the one or more third time periods are determined based on the second set of embeddings.

In some embodiments, a non-transitory computer readable media having stored thereon instructions executable by a processor of a first computing device to cause the first computing device to perform operations including obtain, from a second computing device, a request to perform a processing pipeline, the request defining a first set of computing resources for allocation during a first time period by the first computing device to fulfill the request, obtain, based on the request, a first dataset corresponding to historical data and scheduled pipelines, determine an availability of computing resources at one or more third computing devices during a second time period based on the request, determine, by a model, a recommendation corresponding to a second set of computing resources and a third time period to fulfill the request, the recommendation being determined based on the first dataset and the available computing resources at the one or more third computing devices, and train the model using a reference dataset to predict the second set of computing resources and the third time period capable of fulfilling the request. In some embodiments, the historical data corresponds to at least one of a user ID data, pipeline ID data, pipeline duration data, pipeline code data, requested computing resources data, utilized computing resources data, timestamp data, priority data, and dependencies data.

In some embodiments, the first computing device further performs operations including generate a second dataset as output corresponding to the prediction, send the second dataset to the second computing device, obtain, in response to the second dataset, a third dataset corresponding to a user selection of one or more computing resources during the third time period based on the second set of computing resources, and coordinate with the one or more third computing devices to fulfill the request based on the third dataset. In some embodiments, the first dataset includes historical request data associated with one or more users including a user of the second computing device identified based on attributes of the request from the second computing device.

In some embodiments, training the model using the reference dataset to predict the second set of computing resources and the third time period capable of fulfilling the request further includes obtain a fourth dataset corresponding to a baseline dataset combined with historical data identified based on the scheduled pipelines and completed pipelines and based on the request, extract a first set of embeddings and second set of embeddings based on attributes of the request and based on the fourth dataset, and determine the reference dataset corresponding to a prediction of one or more sets of computing resources based on the first set of embeddings and a prediction of one or more third time periods based on the second set of embeddings.

In some embodiments, extracting the first set of embeddings based on attributes of the request and based on the fourth dataset further includes determine a first matrix based on the first set of embeddings, map one or more attributes to one or more indices of the first matrix, generate a second matrix based on the mapping, and perform a matrix factorization on the second matrix to one or more matrices to enable the model to determine computing resource recommendations, the matrix factorization enables the model to determine user preferences and pipeline characteristics based on weightings associated with the computing resources to make predictions in response to the request.

In some embodiments, extracting the second set of embeddings based on the attributes of the request and based on the fourth dataset further includes allocate the attributes of the third dataset into a plurality of collection buckets based on a classification, identify past pipeline behaviors based on the second set of embeddings, and identify, based on computing resource utilization at the one or more third computing devices, one or more third time periods based on the second set of embeddings, the one or more third time periods are determined based on the second set of embeddings.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

What is claimed is:

1. A system comprising:
a first computing device comprising:
a processor; and
a memory comprising a non-transitory computer readable media having stored therein instructions executable by the processor to perform operations including:
obtain, from a second computing device, a request to perform a processing pipeline during a first time period, the request defining a first set of computing resources for allocation by the first computing device to fulfill the request,
obtain, based on the request, a first dataset corresponding to historical data and scheduled pipelines,
determine an availability of computing resources at one or more third computing devices during a second time period based on the request, and
predict, by a model, a recommendation corresponding to a second set of computing resources and a third time period to fulfill the request, the prediction being determined based on the first dataset and the available computing resources at the one or more third computing devices.

2. The system of claim 1, wherein the processor further performs operations comprising:
generate a second dataset as output corresponding to the prediction;
send the second dataset to the second computing device;
obtain, in response to the second dataset, a third dataset corresponding to a user selection of one or more computing resources during a third time period based on the second set of computing resources; and
coordinate with the one or more third computing devices to fulfill the request based on the third dataset.

3. The system of claim 2, wherein predicting the second set of computing resources and the third time period further comprises:
determine the second set of computing resources predicted to fulfill the request based on applying a first model to the first dataset,
determine one or more third time periods predicted to fulfill the request based on applying a second model to the first dataset, and
combine predictions of the second set of computing resources and the one or more third time periods to generate the second dataset.

4. The system of claim 3, wherein the first dataset comprises historical request data associated with one or more users identified based on attributes of the request from the second computing device.

5. The system of claim 3, wherein the first dataset comprises historical request data associated with a user of the second computing device identified based on attributes of the request from the second computing device.

6. The system of claim 1, wherein the first computing device is capable of dynamically utilizing computing resources at each of the one or more third computing devices to fulfill processing tasks for one or more pipelines from one or more second computing devices.

7. The system of claim 1, wherein the processor further performs operations comprising:
train the model using a reference dataset to predict the second set of computing resources and the third time period capable of fulfilling the request.

8. The system of claim 7, wherein the processor further performs operations comprising:
obtain a fourth dataset corresponding to a baseline dataset combined with historical data identified based on the scheduled pipelines and completed pipelines and based on the request,
extract a first set of embeddings and second set of embeddings based on attributes of the request and based on the fourth dataset, and
determine the reference dataset corresponding to a prediction of one or more sets of computing resources based on the first set of embeddings and a prediction of one or more time periods based on the second set of embeddings.

9. The system of claim 8, wherein the historical data corresponds to at least one of a user ID data, pipeline ID data, pipeline duration data, pipeline code data, requested computing resources data, utilized computing resources data, timestamp data, priority data, and dependencies data.

10. A computer-implemented method for using neural network models to predict available resources comprising:
obtaining, by a first computing device from a second computing device, a request to perform a processing pipeline, the request defining a first set of computing resources for allocation during a first time period by the first computing device to fulfill the request;
obtaining, based on the request, a first dataset corresponding to historical data and scheduled pipelines;
determining, by a neural network model, an availability of computing resources at one or more nodes during a second time period based on the request;
determining, by the neural network model, a recommendation corresponding to a second set of computing resources and one or more third time periods to fulfill the request, the recommendation being based on the first dataset and the available computing resources at the one or more nodes;
generate a second dataset as output corresponding to the prediction;
sending the second dataset to the second computing device to obtain, in response to the second dataset, a third dataset corresponding to a user selection of one or more computing resources during a third time period of the one or more third time periods; and
coordinating with the one or more nodes to fulfill the request based on the third dataset;
wherein the first computing device is capable of dynamically utilizing computing resources at each of the one or more nodes to fulfill processing tasks for one or more pipelines from one or more second computing devices.

11. The computer-implemented method of claim 10, wherein predicting the second set of computing resources and the one or more third time periods further comprises:
determining, by a first neural network model, the second set of computing resources predicted to fulfill the request based on the first dataset,
determining, by a second neural network model, the one or more third time periods predicted to fulfill the request based on the first dataset, and
combining predictions of the second set of computing resources and the one or more third time periods to generate the second dataset.

12. The computer-implemented method of claim 10, further comprising:
training the neural network model using a reference dataset to predict the second set of computing resources and the one or more third time periods capable of fulfilling the request.

13. The computer-implemented method of claim 12, further comprising:
obtaining a fourth dataset corresponding to a baseline dataset combined with historical data identified based on the scheduled pipelines and completed pipelines and based on the request,
extracting a first set of embeddings and second set of embeddings based on attributes of the request and based on the fourth dataset, and
determining the reference dataset corresponding to a prediction of one or more sets of computing resources based on the first set of embeddings and a prediction of one or more time periods based on the second set of embeddings;
wherein the historical data corresponds to at least one of a user ID data, pipeline ID data, pipeline duration data, pipeline code data, requested computing resources data, utilized computing resources data, timestamp data, priority data, and dependencies data.

14. The method of claim 13, wherein extracting the first set of embeddings based on attributes of the request and based on the fourth dataset further comprises:
determining a first matrix based on the first set of embeddings;
mapping one or more attributes to one or more indices of the first matrix;
generating a second matrix based on the mapping; and
performing a matrix factorization on the second matrix to one or more matrices to enable the neural network model to determine computing resource recommendations;
wherein the matrix factorization enables the neural network model to determine user preferences and pipeline characteristics based on weightings associated with the computing resources to make predictions in response to the request.

15. The method of claim 13, wherein extracting the second set of embeddings based on the attributes of the request and based on the fourth dataset further comprises:
allocating the attributes of the third dataset into a plurality of collection buckets based on a classification;
identifying past pipeline behavior based on the second set of embeddings; and
identifying, based on computing resource utilization at the one or more third nodes, one or more third time periods based on the second set of embeddings;
wherein the one or more third time periods are determined based on the second set of embeddings.

16. A non-transitory computer readable media having stored thereon instructions executable by a processor of a first computing device to cause the first computing device to perform operations comprising:
obtain, from a second computing device, a request to perform a processing pipeline, the request defining a first set of computing resources for allocation during a first time period by the first computing device to fulfill the request;
obtain, based on the request, a first dataset corresponding to historical data and scheduled pipelines;
determine an availability of computing resources at one or more third computing devices during a second time period based on the request;
determine, by a model, a recommendation corresponding to a second set of computing resources and a third time period to fulfill the request, the recommendation being determined based on the first dataset and the available computing resources at the one or more third computing devices; and
train the model using a reference dataset to predict the second set of computing resources and the third time period capable of fulfilling the request;
wherein the historical data corresponds to at least one of a user ID data, pipeline ID data, pipeline duration data, pipeline code data, requested computing resources data, utilized computing resources data, timestamp data, priority data, and dependencies data.

17. The non-transitory computer readable media of claim 16, wherein the first computing device further performs operations comprising:
generate a second dataset as output corresponding to the prediction;
send the second dataset to the second computing device;
obtain, in response to the second dataset, a third dataset corresponding to a user selection of one or more computing resources during the third time period based on the second set of computing resources; and
coordinate with the one or more third computing devices to fulfill the request based on the third dataset;
wherein the first dataset comprises historical request data associated with one or more users including a user of the second computing device identified based on attributes of the request from the second computing device.

18. The non-transitory computer readable media of claim 16, wherein training the model using the reference dataset to predict the second set of computing resources and the third time period capable of fulfilling the request further comprises:
obtain a fourth dataset corresponding to a baseline dataset combined with historical data identified based on the scheduled pipelines and completed pipelines and based on the request,
extract a first set of embeddings and second set of embeddings based on attributes of the request and based on the fourth dataset, and
determine the reference dataset corresponding to a prediction of one or more sets of computing resources based on the first set of embeddings and a prediction of one or more third time periods based on the second set of embeddings.

19. The non-transitory computer readable media of claim 18, wherein extracting the first set of embeddings based on attributes of the request and based on the fourth dataset further comprises:
determine a first matrix based on the first set of embeddings;
map one or more attributes to one or more indices of the first matrix;
generate a second matrix based on the mapping; and
perform a matrix factorization on the second matrix to one or more matrices to enable the model to determine computing resource recommendations;
wherein the matrix factorization enables the model to determine user preferences and pipeline characteristics based on weightings associated with the computing resources to make predictions in response to the request.

20. The non-transitory computer readable media of claim 19, wherein extracting the second set of embeddings based on the attributes of the request and based on the fourth dataset further comprises:
allocate the attributes of the third dataset into a plurality of collection buckets based on a classification;
identify past pipeline behaviors based on the second set of embeddings; and
identify, based on computing resource utilization at the one or more third computing devices, one or more third time periods based on the second set of embeddings;
wherein the one or more third time periods are determined based on the second set of embeddings.
